(19) United States
(12) Patent Application Publication
(10) Pub. No.: US 2024/0377577 A1
(43) Pub. Date: Nov. 14, 2024

(54) GLASS MATERIAL AND OPTICAL FIBER

(71) Applicant: SUMITOMO ELECTRIC INDUSTRIES, LTD., Osaka (JP)

(72) Inventors: Shin SATO, Osaka (JP); Shinji ISHIKAWA, Osaka (JP); Kazuya TOKUDA, Osaka (JP)

(21) Appl. No.: 18/748,538

(22) Filed: Jun. 20, 2024

(30) Foreign Application Priority Data
May 20, 2024 (JP) 2024-081832

(51) Int. Cl. G02B 6/02

(52) U.S. Cl. CPC G02B 6/0228

(57) ABSTRACT

In a glass material, a full width at half maximum of a first sharp diffraction peak of an X-ray scattering spectrum is 5.9 nm⁻¹ or less.

### TECHNICAL FIELD

The present disclosure relates to a glass material and an optical fiber. This application claims priority based on Japanese Patent Application No. 2024-081832 filed on May 20, 2024, the entire contents of which are incorporated herein by reference.

### BACKGROUND

It is very important to reduce Rayleigh scattering to reduce transmission loss in optical fibers. Rayleigh scattering is caused by the disturbance in the network structure of glass. The disturbance in the network structure of glass depends on a fictive temperature which indicates at which temperature the glass froze. Raman scattering has conventionally been used as an indicator for evaluating the fictive temperature.

US 2017/0305781 A1 discloses that the smaller the ratio, I_{D2}/I_{ω3}, of the intensity of Raman scattered light D2 due to the three-membered ring structures of silica to the intensity of Raman scattered light ω3 due to Si—O stretching vibration, the lower the fictive temperature.

### SUMMARY

In a glass material according to an aspect of the present disclosure, a full width at half maximum of a first sharp diffraction peak of an X-ray scattering spectrum is 5.9 nm⁻¹ or less.

### BRIEF DESCRIPTION OF THE DRAWINGS

FIG. 1 is a cross-sectional view illustrating an optical fiber according to an embodiment.

FIG. 2 is a diagram illustrating an example of a typical Raman scattering spectrum.

FIG. 3 is a graph illustrating the relationship between transmission loss and the ratio, I_{D2}/I_{ω3}, in an optical fiber.

FIG. 4 is a diagram illustrating the Raman spectrum of glass to which potassium has been added in a mass fraction of 10%.

FIG. 5 is a diagram illustrating the Raman spectrum of glass manufactured by applying 4 GPa.

FIG. 6 is a diagram illustrating a first sharp diffraction peak of an X-ray scattering spectrum of an optical fiber.

FIG. 7 is a graph illustrating the relationship between transmission loss and the full width at half maximum of a first sharp diffraction peak of an X-ray scattering spectrum of an optical fiber having silica as its major component.

FIG. 8 is a graph illustrating the relationship between transmission loss and the full width at half maximum of a first sharp diffraction peak of an X-ray scattering spectrum of an optical fiber in which the core includes germanium.

### DETAILED DESCRIPTION

### Problem to be Solved by the Present Disclosure

Given that there is a smaller number of non-six-membered ring structures such as three-membered ring structures and other elements with respect to the number of six-membered ring structures of silica, the fictive temperature can be appropriately represented by the proportion of the three-membered ring structures such as that disclosed in US 2017/0305781 A1. However, when the premise above is not true, the proportion of the three-membered ring structures does not necessarily correlate with the fictive temperature. That is, the rise in the fictive temperature does not necessarily mean a disturbance in the network structure of glass, thus an increase in transmission loss.

For example, in glass to which an element other than silicon (Si) and oxygen (O) has been added at a high concentration, the absolute number of the basic network structures of Si—O decreases. Thus, the fictive temperature represented by the proportion of the three-membered ring structures increases. The transmission loss may decrease in this case.

For example, small-membered ring structures including three-membered ring structures and four-membered ring structures develop in densified glass. The fictive temperature represented by the proportion of the three-membered ring structures increases. However, it is known that the transmission loss decreases since an ordered structure has in fact developed.

It is thus difficult to control the reduction in Rayleigh scattering with the proportion of non-six-membered ring structures as an indicator. It would be desirable to evaluate the uniformity of the network structure of glass regardless of the number of members in the main ring structure, to thereby achieve glass having a high network structure uniformity.

The present disclosure provides glass having a high network structure uniformity regardless of the number of members in the main ring structure, and an optical fiber.

### Advantageous Effects of the Present Disclosure

The present disclosure provides glass having a high network structure uniformity regardless of the number of members in the main ring structure, and an optical fiber.

Embodiments of the present disclosure will first be listed and described.

(1) In a glass material according to an aspect of the present disclosure, a full width at half maximum of a first sharp diffraction peak of an X-ray scattering spectrum is 5.9 nm⁻¹ or less.

This glass material has a high network structure uniformity regardless of the number of members in the main ring structure.

(2) An optical fiber according to an aspect of the present disclosure includes a core and a cladding surrounding the core, wherein a value obtained by weighting, in a region of a diameter of 20 μm, a core radial distribution of a full width at half maximum of a first sharp diffraction peak of an X-ray scattering spectrum by an electric field distribution of guided light of a wavelength of 1550 nm calculated based on a refractive index profile is 5.9 nm⁻¹ or less.

This optical fiber has a high network structure uniformity regardless of the number of members in the main ring structure. Consequently, transmission loss can be reduced.

(3) In (2) above, the difference between a maximum value and a minimum value of the value inside the core may be 0.6 nm⁻¹ or less. In this case, the scattering intensity caused by the difference in the radial uniformity of glass can be suppressed.

(4) An optical fiber according to an aspect of the present disclosure includes a core including germanium and a cladding surrounding the core, wherein a value obtained by weighting, in a region of a diameter of 20 μm, a core radial distribution of a full width at half maximum of a first sharp diffraction peak of an X-ray scattering spectrum by an electric field distribution of guided light of a wavelength of 1550 nm calculated based on a refractive index profile is 7.0 nm⁻¹ or less.

This optical fiber has a high network structure uniformity regardless of the number of members in the main ring structure. Consequently, transmission loss can be reduced.

(5) In (4) above, the difference between a maximum value and a minimum value of the value inside the core may be 0.4 nm⁻¹ or less. In this case, the scattering intensity caused by the difference in the radial uniformity of glass can be suppressed.

### Details of Embodiments of the Present Disclosure

Specific examples of the glass material and the optical fiber of the present disclosure will be described in detail below with reference to the drawings. It should be noted that the present disclosure is not limited to these examples, but is defined by the scope of the claims, and is intended to include all modifications within the meaning and scope equivalent to the scope of the claims. Same reference signs are given to the same elements in the description of the drawings, and redundant description will be omitted.

### (Glass Material)

A glass material according to an embodiment is used, for example, as a material of an optical fiber. The glass material includes, for example, an oxide or a fluoride as its major component (matrix). The oxide is, for example, silica (SiO₂) or alumina (Al₂O₃). The concentration of the major component may be 50% or more, 80% or more, or 90% or more in mass fraction.

The glass material may include, as a minor component, an alkaline metal element such as Li, Na, K, Rb, and Cs, an alkaline earth metal element such as Be, Mg, Ca, Sr, and Ba, a group 13 element such as B, Al, Ga, and In, a group 14 element such as Ge and Sn, a group 15 element such as P and N, or a group 17 element such as F, Cl, Br, and I. The glass material may simultaneously include a plurality of these elements.

In general, adding an element different from the major component of the glass provides an effect of weakening the network bond of the major component which is, for example, an oxide. This tends to promote structural relaxation at high temperatures. On the other hand, when the concentration is increased too much, the effect of network breakdown due to the addition itself increases too much, and the uniformity of the glass network decreases. Consequently, the total concentration of the elements of the minor component may be from 0.0010% to 20%, from 0.01% to 15%, or from 0.10% to 10% in mass fraction.

Of the compositions above, glass having SiO₂ as the major component may be densified glass. The glass density may be 2.21 g/cm³ or more, 2.25 g/cm³ or more, or 2.3 g/cm³ or more. In densified glass, the structure of glass is uniform as there is a large number of three-membered ring structures and four-membered ring structures of silica. For example, densified glass can be obtained by applying a high pressure. By densifying the glass, the refractive index of the glass changes. The refractive index of ordinary glass (including glass to which various elements are added) is, for example, 1.45 or more and 1.47 or less. The refractive index of the densified glass is, for example, 1.47 or more and 1.56 or less.

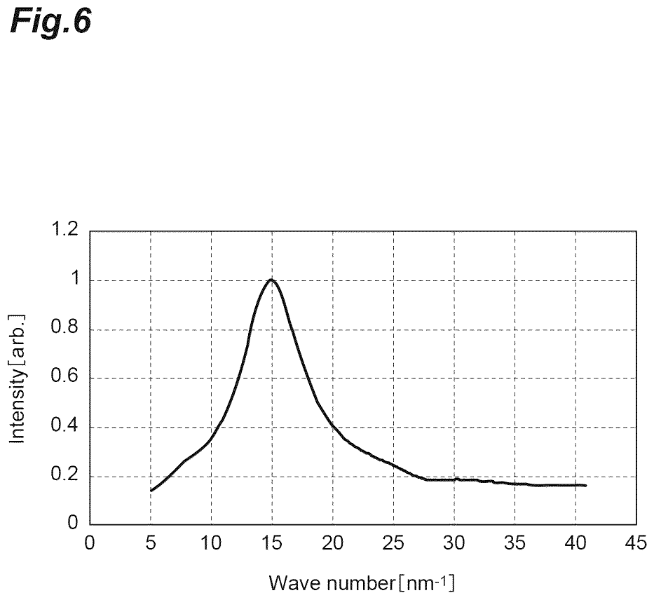

In the glass material, a full width at half maximum of a first sharp diffraction peak (FSDP) of an X-ray scattering spectrum is 5.9 nm¹ or less. The full width at half maximum of the FSDP can represent the uniformity of the glass structure regardless of the number of members in the main ring structure. The FSDP will be described further below with reference to FIG. 6. In the glass material in which the FSDP is 5.9 nm⁻¹ or less, there is less disturbance in the network structure of the glass, and the uniformity of that structure is high. The full width at half maximum of the FSDP may be 5.7 nm⁻¹ or less, or 5.3 nm⁻¹ or less. In the glass material in which the FSDP is 5.7 nm⁻¹ or less, there is much less disturbance, and the uniformity is higher. In the glass material in which the FSDP is 5.3 nm⁻¹ or less, there is even less disturbance, and the uniformity is even higher.

### (Optical Fiber)

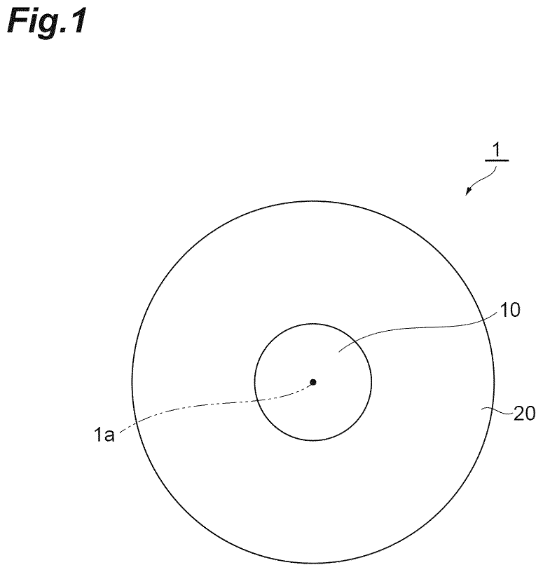

FIG. 1 is a cross-sectional view illustrating an optical fiber according to an embodiment. As illustrated in FIG. 1, an optical fiber 1 according to the embodiment includes a core 10 and a cladding 20. Core 10 and cladding 20 include the glass material according to the embodiment. The composition of core 10 and the composition of cladding 20 may be the same or different.

Core 10 extends along a central axis 1a of optical fiber 1. There may be one or two or more cores 10. That is, optical fiber 1 may be a single core optical fiber or a multicore optical fiber. In the case in which optical fiber 1 is a multicore optical fiber, the compositions of cores 10 may be the same or different. Core 10 has a diameter (core diameter) of, for example, from 4.5 μm to 15 μm.

Cladding 20 surrounds core 10. Cladding 20 in the illustrated example has a single layer structure, but it may have a multilayer structure. Cladding 20 having a multilayer structure may, for example, have an optical cladding and a physical cladding called a jacket. Cladding 20 has a diameter, for example, of 125 μm.

Core 10 has a refractive index higher than a refractive index of cladding 20. A relative refractive index difference Δ between core 10 and cladding 20 is, for example, from 0.25% to 0.4%.

Optical fiber 1 may be treated with deuterium (D₂) after being fiberized. This promotes the suppression of defect absorption loss, and structural relaxation due to the elimination of defect structures.

Optical fiber 1 includes core 10 and cladding 20, and has different materials and heat distributions depending on the location in a position in a plane perpendicular to central axis 1a. In this case, a full width at half maximum of a FSDP in optical fiber 1 is not necessarily uniform in the plane perpendicular to central axis 1a. Consequently, a core radial distribution of the full width at half maximum of the FSDP is weighted by an intensity distribution of guided light when calculating the full width at half maximum of the FSDP in optical fiber 1. In the case of a multicore optical fiber, each of cores 10 is weighted.

Weighting is performed, for example, in a region of a predetermined diameter about a central axis of core 10. A predetermined diameter is a core diameter or more, and a distance between central axes of adjacent cores 10 or less. In a case in which the central axis of core 10 matches central axis 1a of optical fiber 1, the core radial distribution of the full width at half maximum of the FSDP matches a radial distribution of the full width at half maximum of the FSDP. Specifically, a value obtained by weighting, in a region of a diameter of 20 μm (i.e., a region included within a radius of 10 μm from the central axis of core 10), the core radial distribution of the full width at half maximum of the FSDP of an X-ray scattering spectrum by an electric field distribution of guided light of a wavelength of 1550 nm calculated based on a refractive index profile is used as the full width at half maximum of the FSDP of optical fiber 1.

In optical fiber 1, the full width at half maximum of the FSDP is 5.9 nm⁻¹ or less. This reduces the disturbance in the network structure of the glass, which thereby reduces transmission loss. The full width at half maximum of the FSDP may be 5.7 nm⁻¹ or less. The transmission loss can further be reduced in this case. The full width at half maximum of the FSDP may be 5.3 nm⁻¹ or less. The transmission loss can even further be reduced in this case. The full width at half maximum of the FSDP of optical fiber 1 may be 3 nm⁻¹ or more, 4 nm⁻¹ or more, or 5 nm⁻¹ or more.

The smaller the difference between the maximum and minimum values of the full width at half maximum of the FSDP (hereinafter, also referred to as the “difference in the full width at half maximum”) at the same location, the more effective for improving the uniformity of the glass. Here, the location refers to core 10 and cladding 20. In the case in which cladding 20 has a multilayer structure, the location may be each layer of cladding 20 such as the optical cladding and the physical cladding.

In particular, the smaller the difference in the full width at half maximum of the FSDP inside core 10, the more effective for improving the uniformity of the glass. The difference in the full width at half maximum of the FSDP inside core 10 may be 0.6 nm⁻¹ or less, 0.4 nm⁻¹ or less, or 0.2 nm⁻¹ or less. Additionally, the smaller the difference in the full width at half maximum of the FSDP inside cladding 20, the more effective for improving the uniformity of the glass. The difference in the full width at half maximum of the FSDP inside cladding 20 may be 1.0 nm⁻¹ or less, 0.8 nm⁻¹ or less, or 0.6 nm⁻¹ or less. This can suppress the scattering intensity caused by the difference in the radial uniformity of the glass.

### (Germanium-Doped Core)

In a case in which core 10 includes germanium (Ge), the full width at half maximum of the FSDP of optical fiber 1 is 7.0 nm⁻¹ or less. This reduces the disturbance in the network structure of the glass, which thereby reduces transmission loss. The full width at half maximum of the FSDP may be 6.7 nm⁻¹ or less. The transmission loss can further be reduced in this case. The full width at half maximum of the FSDP may be 6.6 nm⁻¹ or less. The transmission loss can even further be reduced in this case. The full width at half maximum of the FSDP of optical fiber 1 may be 3 nm⁻¹ or more, 4 nm⁻¹ or more, or 5 nm⁻¹ or more.

Also in the case in which core 10 includes germanium, the smaller the full width at half maximum of the FSDP at the same location, the more effective for improving the uniformity of the glass. In particular, the smaller the difference in the full width at half maximum of the FSDP inside core 10, the more effective for improving the uniformity of the glass. The difference in the full width at half maximum of the FSDP inside core 10 may be 0.6 nm⁻¹ or less, 0.4 nm⁻¹ or less, or 0.2 nm⁻¹ or less.

Additionally, the smaller the difference in the full width at half maximum of the FSDP inside cladding 20, the more effective for improving the uniformity of the glass. The difference in the full width at half maximum of the FSDP inside cladding 20 may be 0.7 nm⁻¹ or less, 0.5 nm⁻¹ or less, or 0.3 nm⁻¹ or less. This can suppress the scattering intensity caused by the difference in the radial uniformity of the glass. The difference in the full width at half maximum of the FSDP of the whole fiber may be 0.8 nm⁻¹ or less, 0.6 nm⁻¹ or less, or 0.4 nm⁻¹ or less.

### (Evaluation Method of Low-Loss Characteristics)

The evaluation method of low-loss characteristics disclosed in US 2017/0305781 A1 will first be described. In this method, the ratio, I_{D2}/I_{ω3}, in a Raman scattering spectrum is used. This method is limited to silica glass.

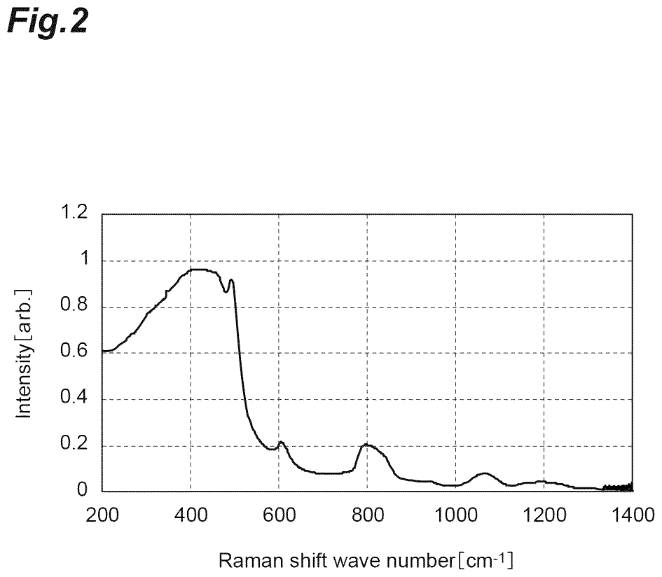

FIG. 2 is a diagram illustrating an example of a typical Raman scattering spectrum. In general, irradiating matter with light generates Raman scattered light of a wavelength different from the wavelength of the irradiated light due to the interaction of the light with the matter (molecular vibration). The molecular-level structure of the matter can be analyzed by a Raman scattering spectrum obtained by splitting the Raman scattered light. A typical Raman scattering spectrum such as that illustrated in FIG. 2 can be obtained by irradiating silica glass with laser light of a wavelength of 532 nm. In FIG. 2, Raman scattered light ω3 due to Si—O stretching vibration is found in the wavenumber range of from 750 cm⁻¹ to 875 cm⁻¹. Raman scattered light D2 attributed to silica three-membered ring structures is found in the wavenumber range of from 565 cm⁻¹ to 640 cm⁻¹. Raman scattered light D1 attributed to silica four-membered ring structures is found in the wavenumber range of from 475 cm⁻¹ to 525 cm⁻¹.

An intensity I_{ω3} of Raman scattered light ω3 is represented by an average intensity of the region interposed between the Raman scattering spectrum and a baseline drawn from 750 cm⁻¹ to 875 cm⁻¹ of the wavenumber range in the Raman scattering spectrum. An intensity I_{D2} of Raman scattered light D2 is represented by an average intensity of the region interposed between the Raman scattering spectrum and a baseline drawn from 565 cm⁻¹ to 640 cm⁻¹ of the wavenumber range in the Raman scattering spectrum.

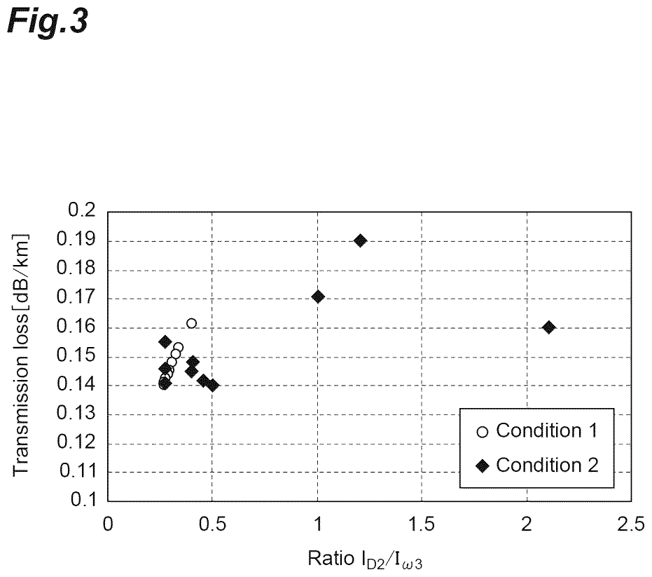

FIG. 3 is a graph illustrating the relationship between transmission loss and the ratio, I_{D2}/I_{ω3}, in an optical fiber. FIG. 3 shows data of an optical fiber manufactured under Conditions 1 and 2. The optical fiber manufactured under Condition 1 has a conventional glass composition range composed mainly of six-membered ring structures of silica. As described above, the main ring structure need not necessarily be limited to the six-membered ring structure to reduce Rayleigh scattering. The optical fiber manufactured under Condition 2 has a new glass composition range that has been uniformized centered on three- or four-membered ring structures of silica or ring structures composed mainly of other elements. In the optical fiber manufactured under Condition 1, the transmission loss correlates with the ratio, I_{D2}/I_{ω3}, whereas in the optical fiber manufactured under Condition 2, the transmission loss does not necessarily correlate with the ratio, I_{D2}/I_{ω3}.

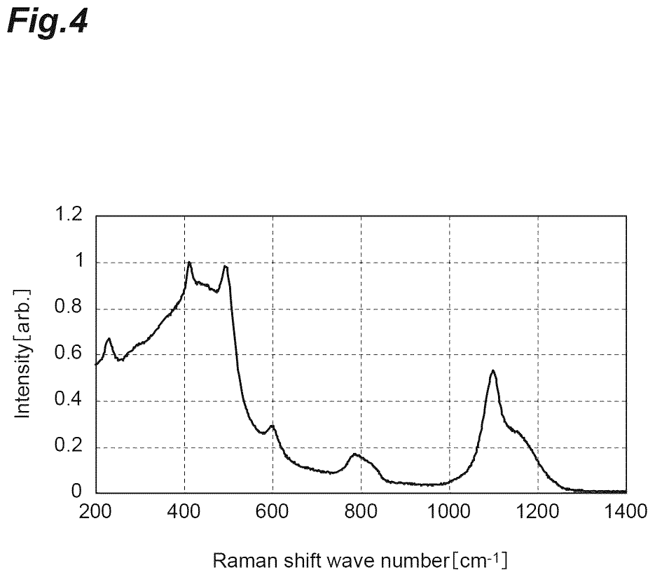

FIG. 4 is a diagram illustrating the Raman spectrum of glass to which potassium (K) has been added in a mass fraction of 10%. The six-membered ring structures have collapsed due to the addition of an element at a high concentration, and a peak caused by non-bridging oxygen is generated in the vicinity of the wavenumber 1100 cm⁻¹ as illustrated in FIG. 4. The actual uniformity of the glass structure cannot be properly evaluated by the ratio, I_{D2}/I_{ω3}, since the proportion of the six-membered ring structures of silica has decreased.

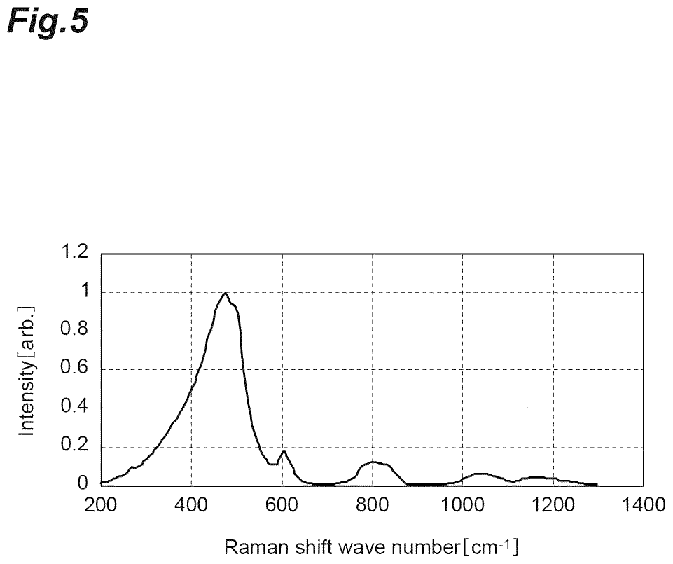

FIG. 5 is a diagram illustrating the Raman spectrum of glass manufactured by applying 4 GPa. In the case of such high pressure-applied glass (densified glass), the shape of the Raman spectrum changes as illustrated in FIG. 5 due to an increase in the smaller-membered rings of the glass structure. The proportion of the six-membered ring structures of silica of the entire glass has also decreased in this case.

The present inventors have resolved the problem above, and have found that evaluations using the FSDP of an X-ray scattering spectrum are desirable to secure low transmission loss. FIG. 6 is a diagram illustrating the FSDP of an X-ray scattering spectrum of an optical fiber. The X-ray scattering spectrum is measured using, for example, an X-ray of an incident energy band of 8.3 keV. The first maximum value in a range in which a wavenumber q(Å⁻¹) satisfies q≥1 Å⁻¹ (i.e., 10 nm⁻¹) is selected as the FSDP. For example, in the case of pure silica, the FSDP is obtained in the vicinity of 1.6 1 Å⁻¹ (i.e., the vicinity of 16 nm⁻¹).

The full width at half maximum of the FSDP is obtained by performing fitting of A, μ_{L}, μ_{H}, B, w, y₀, y₁ using a divided pseudo-Voigt function. When x<x_{c}, the following function is obtained. When x>x_{c}, a formula in which B in the following function is replaced with 1/B and μ_{H} in the following function is replaced with μ_{L} is obtained.
Reference Document: H. Toraya, J. Appl. Crystallogr. 23, 485 (1990)

$$y ( x ) - {y}_{0} + {y}_{1} x + A \frac{( 1 + B ) [ {μ}_{H} + \sqrt{πln2} ( 1 - {μ}_{H} ) ]}{{μ}_{L} + \sqrt{πln2 ( 1 - {μ}_{L} ) + B [ {μ}_{H} + \sqrt{2} ( 1 - {μ}_{H} ) ]}} \{ {μ}_{L} {\frac{2}{π w} [ 1 + {( \frac{1 + B}{B} )}^{2} {( \frac{x - {x}_{c}}{w} )}^{2} ]}^{- 1} + ( 1 - {μ}_{L} ) {( \frac{ln 2}{π} )}^{1 / 2} \frac{2}{w} exp [ - ln 2 {( \frac{1 + B}{B} )}^{2} {( \frac{x - {x}_{c}}{w} )}^{2} ] \}$$

The FSDP is an indicator originating from the distance between the bonds of the major component glass, and the full width at half maximum thereof indicates the variation in the bond length of the major component glass. Consequently, the full width at half maximum of the FSDP is a very appropriate method for representing the uniformity of the medium range order of the glass structure which causes Raleigh scattering. It is also very suitable for evaluating the relationship between Raleigh scattering and loss regardless of the main ring structure or the main type of oxide.

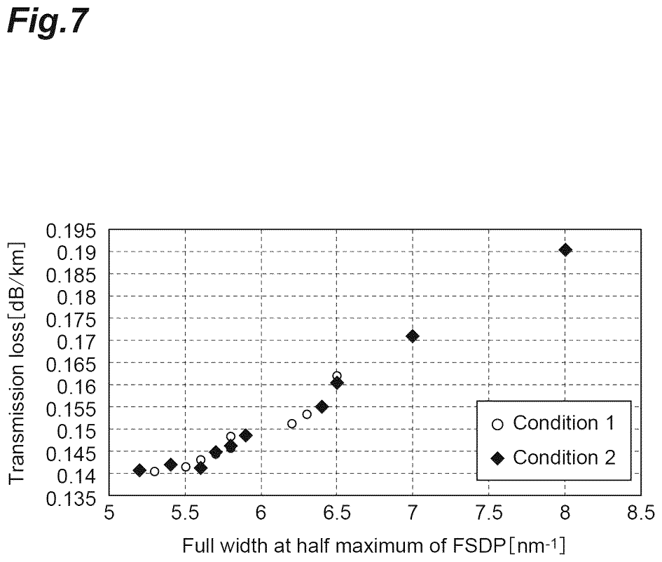

FIG. 7 is a graph illustrating the relationship between transmission loss and the full width at half maximum of a FSDP of an X-ray scattering spectrum of an optical fiber having silica as its major component. Here, the full width at half maximum of the FSDP of the optical fiber is a value calculated by weighting by the intensity distribution of guided light as described above. In a case in which the full width at half maximum of the FSDP of 5.9 nm⁻¹ or less is the state of the glass (i.e., the state of the optical fiber) during the measurement of transmission loss, it can be confirmed that a transmission loss of 0.150 dB/km or less can be achieved. In the case in which the value above is 5.7 nm⁻¹ or less, it can be confirmed that a transmission loss of 0.145 dB/km or less can be achieved. In the case in which the value above is 5.3 nm⁻¹ or less, it can be confirmed that a transmission loss of 0.141 dB/km or less can be achieved.

### (Germanium-Doped Core)

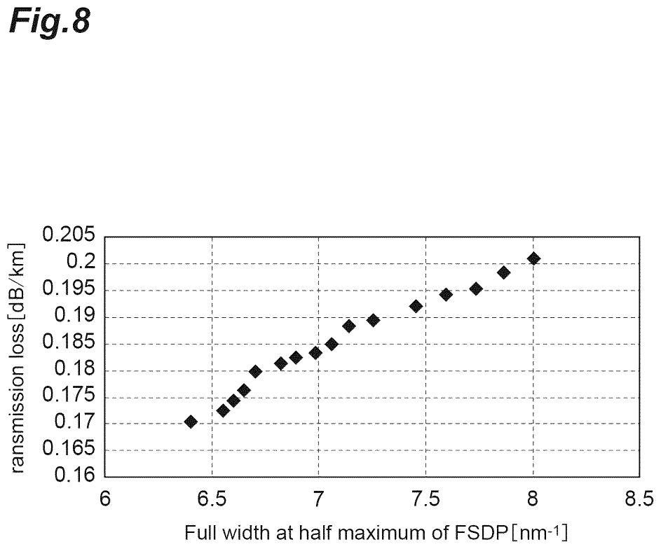

The case in which the core includes germanium will be described. FIG. 8 is a graph illustrating the relationship between transmission loss and the full width at half maximum of a FSDP of an X-ray scattering spectrum of an optical fiber in which the core includes germanium. Here, the full width at half maximum of the FSDP of the optical fiber is also a value calculated by weighting by the intensity distribution of guided light as described above. In a case in which the full width at half maximum of the FSDP of 7.0 nm⁻¹ or less is the state of the glass (i.e., the state of the optical fiber) during the measurement of transmission loss, it can be confirmed that a transmission loss of 0.185 dB/km or less can be achieved. In the case in which the value above is 6.7 nm⁻¹ or less, it can be confirmed that a transmission loss of 0.180 dB/km or less can be achieved. In the case in which the value above is 6.6 nm⁻¹ or less, it can be confirmed that a transmission loss of 0.175 dB/km or less can be achieved.

Although the embodiments have been described, the present disclosure is not necessarily limited to the embodiments described above, and various modifications are possible without departing from the gist thereof.

What is claimed is:

1. A glass material wherein a full width at half maximum of a first sharp diffraction peak of an X-ray scattering spectrum is 5.9 nm⁻¹ or less.

2. An optical fiber comprising a core and a cladding surrounding the core, wherein a value obtained by weighting, in a region of a diameter of 20 μm, a core radial distribution of a full width at half maximum of a first sharp diffraction peak of an X-ray scattering spectrum by an electric field distribution of guided light of a wavelength of 1550 nm calculated based on a refractive index profile is 5.9 nm⁻¹ or less.

3. The optical fiber according to claim 2, wherein a difference between a maximum value and a minimum value of the value inside the core is 0.6 nm⁻¹ or less.

4. An optical fiber comprising a core including germanium and a cladding surrounding the core, wherein a value obtained by weighting, in a region of a diameter of 20 μm, a core radial distribution of a full width at half maximum of a first sharp diffraction peak of an X-ray scattering spectrum by an electric field distribution of guided light of a wavelength of 1550 nm calculated based on a refractive index profile is 7.0 nm⁻¹ or less.

5. The optical fiber according to claim 4, wherein a difference between a maximum value and a minimum value of the value inside the core is 0.4 nm⁻¹ or less.
